(19) United States
(12) Patent Application Publication
(10) Pub. No.: US 2021/0252759 A1
(43) Pub. Date: Aug. 19, 2021

(54) DEVICE AND METHOD FOR PRODUCING SEAT SHELLS FOR VEHICLE SEATS

(71) Applicant: ADIENT ENGINEERING AND IP GMBH, BURSCHEID (DE)

(72) Inventors: JOERG JONAS, WUELFRATH (DE); UWE REICHEL, KAISERSLAUTERN (DE); LARS KRAMM, TRIPPSTADT (DE)

(73) Assignee: ADIENT ENGINEERING AND IP GMBH, BURSCHEID (DE)

(21) Appl. No.: 17/251,256

(22) PCT Filed: Jun. 11, 2019
(86) PCT No.: PCT/EP2019/065106

§ 371 Date: Dec. 11, 2020

(30) Foreign Application Priority Data
Jun. 13, 2018 (DE) 10 2018 209 429.2

(51) Int. Cl. B29C 45/26; B29C 45/14

(52) U.S. Cl. CPC B29C 45/2673; B29L 2031/3005; B29C 2045/14286; B29C 45/14221

(57) ABSTRACT

A device for producing seat shells for vehicle seats may have an injection molding tool, in which an injection molding compound, in particular of a plastic, particularly of a thermoplastic plastic, can be molded on a semi-finished product, in particular an organo-sheet. The semi-finished product may be at least lateral cheeks of the respective seat shell, wherein a cavity in the injection molding tool can be modified in a forming region for the lateral cheeks.

The invention relates to a device and to a method for producing seat shells for vehicle seats.

Devices and methods for producing seat shells for vehicle seats are widely known in the prior art.

It is the object of the present invention to specify a device that is improved over the prior art and to specify a method that is improved over the prior art for producing seat shells for vehicle seats.

According to the invention, the object is achieved by means of a device for producing seat shells for vehicle seats having the features of claim 1 and by means of a method for producing seat shells for vehicle seats having the features of claim 5.

Advantageous embodiments of the invention form the subject matter of the dependent claims.

A device according to the invention for producing seat shells, also referred to as seat cushion shells, for vehicle seats comprises an injection molding tool. In this injection molding tool, an injection molding compound, in particular composed of a plastic, in particular of a thermoplastic, can be molded onto a semifinished product, in particular onto a composite sheet, in order to form at least lateral cheeks of the respective seat shell. A cavity in the injection molding tool can be modified in a forming region for the lateral cheeks.

Through the modifiable cavity in the injection molding tool, the device according to the invention makes possible low-cost formation of different seat shell versions. By virtue of the solution according to the invention, different embodiments of seat shells, which differ at least in the lateral cheek height thereof, can be produced with the same injection molding tool. For this purpose, all that is required is to carry out appropriate modification of the cavity in the injection molding tool in the forming region for the lateral cheeks.

In one possible embodiment, interchangeable inserts are provided that can be inserted into the injection molding tool in order to modify the cavity in the injection molding tool in the forming region for the lateral cheeks. As a result, it is possible to use the same injection molding tool to produce different embodiments of seat shells, which differ at least in the lateral cheek height thereof, for which purpose all that is required is to arrange or remove the interchangeable inserts or, when using a plurality of interchangeable insert types for the various lateral cheek heights, to arrange the interchangeable inserts of the respective interchangeable insert type.

The interchangeable inserts can each be secured positively and/or nonpositively in the injection molding tool, for example. As a result, secure fastening in the injection molding tool is made possible, and it is ensured that the interchangeable inserts, when not required or when they are to be exchanged for interchangeable inserts of a different interchangeable insert type, can be removed from the injection molding tool again in a simple manner, in particular without damage to the injection molding tool and the interchangeable inserts.

In one possible embodiment, at least two interchangeable insert types are provided, which differ in particular in the height thereof. The interchangeable inserts of the respective interchangeable insert type can be selected and should be arranged in the injection molding tool according to the envisaged lateral cheek height to be formed. It is advantageous if the interchangeable inserts of the interchangeable insert type of great height are used to reduce the cavity in the forming region for the lateral cheeks to a greater extent, thus enabling the embodiment of the seat shell with the low lateral cheeks to be produced, and the interchangeable inserts of the interchangeable insert type of low height are used to reduce the cavity in the forming region for the lateral cheeks to a lesser extent, thus enabling the embodiment of the seat shell with the high lateral cheeks to be produced.

As an alternative, provision can be made, for example, for interchangeable inserts only of one interchangeable insert type to be present, these interchangeable inserts being inserted into the injection molding tool, when the intention is to form seat shells with low lateral cheeks, in order to reduce the cavity in the injection molding tool appropriately in the forming region for the lateral cheeks, and being removed from the injection molding tool when the intention is to produce seat shells with high lateral cheeks, with the result that the complete cavity, in particular the complete cavity height, of the injection molding tool is then available in the injection molding tool, in the forming region for the lateral cheeks, for the formation of the high lateral cheeks.

The embodiment of the seat shell with high lateral cheeks is, in particular, a sporty embodiment, in which the lateral cheeks are formed with a greater height for greater lateral retention. The embodiment of the seat shell with low lateral cheeks is, in particular, a basic version. The lateral cheeks of lower height make it easier for an occupant to climb in and out.

In a method according to the invention for producing seat shells for vehicle seats, this device is used to produce at least two different embodiments of seat shells, which differ in lateral cheek height, by adjusting the cavity in the injection molding tool in the forming region for the lateral cheeks in accordance with the respective embodiment of the seat shell to be produced. This results in the advantages already explained in relation to the device. In particular, it is possible by means of the method and by using the device to achieve formation of different seat shell versions in a low-cost way, wherein the versions, i.e. the embodiments, of the seat shell differ at least in the lateral cheek height. For this purpose, all that is required is to adjust the cavity in the injection molding tool in the forming region for the lateral cheeks in accordance with the respective embodiment of the seat shell that is to be produced.

In one possible embodiment of the method, the interchangeable inserts are used to modify the cavity in the injection molding tool in the forming region for the lateral cheeks, wherein the embodiment of the seat shell with low lateral cheeks is produced by arranging interchangeable inserts in the injection molding tool, and the embodiment of the seat shell with high lateral cheeks is produced by not arranging interchangeable inserts in the injection molding tool or by arranging in said tool interchangeable inserts of a different interchangeable insert type which have a lower height than the interchangeable inserts used to produce the embodiment of the seat shell with low lateral cheeks. As a result, it is possible by means of the method and by using the device to achieve the formation of different seat shell versions in a low-cost way, wherein the versions, i.e. the embodiments, of the seat shell differ at least in the lateral cheek height. For this purpose, all that is required is to select the interchangeable inserts of the respective interchangeable insert type in accordance with the respective embodiment of the seat shell to be produced and to arrange them in the injection molding tool or, if interchangeable inserts of only one interchangeable insert type are provided, to arrange these in the injection molding tool if the intention is to produce the embodiment of the seat shell with low lateral cheeks and to remove them from the injection molding tool if the intention is to produce the embodiment of the seat shell with high lateral cheeks.

In particular, the respective seat shell is produced by inserting a semifinished product, in particular a composite sheet, into the injection molding tool and molding on an injection molding compound, in particular composed of a plastic, in particular of a thermoplastic, in order to form at least the lateral cheeks of the seat shell. A composite component which has a high strength and stiffness and a low weight and is formed in a shape advantageous for an occupant is thereby formed.

For example, reinforcing structures, in particular rib structures and/or honeycomb structures, and/or at least one receptacle for an attachment to be secured on the vehicle seat or a plurality of such receptacles for a plurality of attachments are furthermore formed by the molding on of the injection molding compound. It is thereby possible to improve a strength and stiffness, and/or it is possible in a simple manner to secure one or more attachments on the vehicle seat.

For example, the semifinished product is heated before insertion into the injection molding tool until it can be deformed, and is formed before insertion into the injection molding tool or in the injection molding tool. The composite sheet is particularly suitable as a semifinished product for this purpose. A composite sheet of this kind is a fiber composite component, wherein the as yet unshaped composite sheet is, in particular, a semifinished fiber matrix product consisting of a woven or non-crimped fabric embedded in a thermoplastic. The composite sheet can be hot formed, e.g. by being heated by infrared light irradiation and then formed, e.g. by insertion into a corresponding mold, e.g. by insertion into the injection molding tool. In particular, the composite component consisting of the composite sheet and the molded-on injection molding compound has a low weight and a high stability.

The production of the seat shell as a composite component takes place, in particular, in an automated manufacturing process by the “one-shot hybrid molding process”, wherein the composite component is designed as a composite sheet with a molded-on injection molding compound. By means of the modifiable cavity in the injection molding tool in the forming region for the lateral cheeks, in particular by means of the interchangeable inserts, an adjustable height of the lateral cheeks of the seat shell is achieved here, e.g. by using different interchangeable insert types in order to form the respective lateral cheek height, or, in the case of just one interchangeable insert type, by inserting the interchangeable inserts into the injection molding tool in order to form the embodiment of the seat shell with low lateral cheeks, i.e. with a low lateral cheek height, and removing them from the injection molding tool in order to form the embodiment of the seat shell with high lateral cheeks, i.e. with a great lateral cheek height.

The seat shell as a composite component, together with metal components, in particular steel components, for example, forms a seat substructure of the vehicle seat. Both construction elements are load bearing and formed, in particular designed, in such a way that they accommodate the body of a vehicle occupant and represent as far as possible a minimum block dimension.

“Accommodate” means that the body of the occupant is advantageously at the same distance from these construction elements, in particular from the seat shell, at all points, wherein cushioning is advantageously arranged between the occupant and these construction elements, in particular the seat shell. By virtue of the free configurability of the shape of the composite component, i.e. of the seat shell, the shape of the posterior of the occupant can be accommodated with uniform spacing.

A minimum block dimension means, in particular, a minimum distance from a lower edge of a seat rail at the H point of the vehicle seat, i.e. the hip point. A low seat position and a low center of gravity of the vehicle is thereby achieved. This is advantageous especially in the case of sports seats.

By virtue of the high strength and stiffness of the metal components, the composite component, i.e. the seat shell, is relieved of load in dynamic load cases. In particular, the metal components are designed as a tubular frame. The combination of the composite component, i.e. seat shell, and the tubular frame is advantageously formed in such a way that the forces in the composite component and the tubular frame are dissipated in a preferential direction.

Illustrative embodiments of the invention are explained in greater detail by means of drawings. In the drawings:

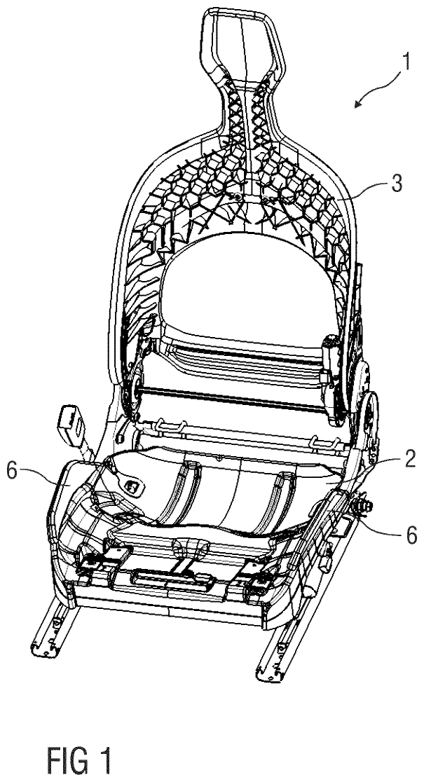

FIG. 1 shows schematically a perspective illustration of a vehicle seat,

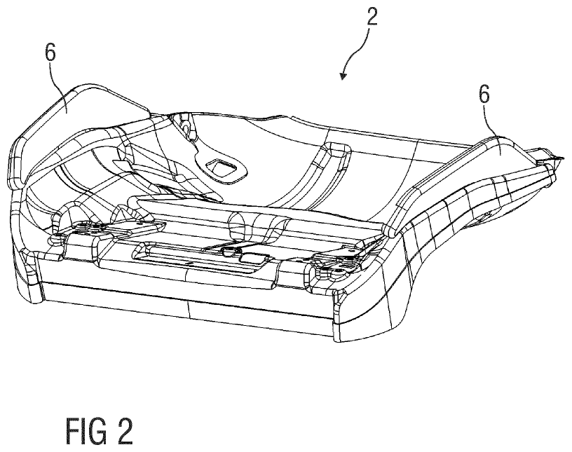

FIG. 2 shows schematically a perspective illustration of one embodiment of a seat shell for a vehicle seat,

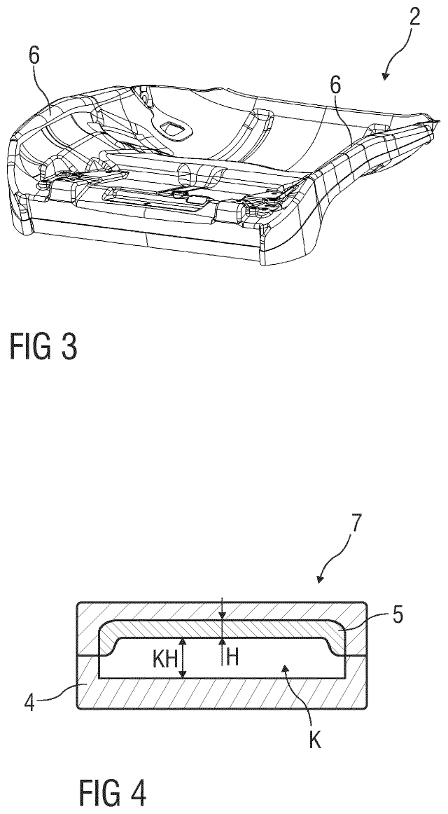

FIG. 3 shows schematically a perspective illustration of another embodiment of a seat shell for a vehicle seat, and

FIG. 4 shows schematically a section through a device for producing seat shells for vehicle seats.

In all the figures, mutually corresponding parts are provided with the same reference signs.

FIG. 1 shows a vehicle seat 1 in a perspective illustration. The vehicle seat 1 comprises a seat shell 2, also referred to as a seat cushion shell, and a seat back 3.

Together with metal components, in particular steel components, which, in particular, are designed in the form of a tubular frame, the seat shell 2 forms a seat substructure for the vehicle seat 1, on which cushioning (not illustrated here) is arranged. A similar statement applies also to the seat back 3, for example.

The seat shell 2 is designed as a composite component. This seat shell 2 can be produced in an automated manufacturing process, in a “one-shot hybrid molding process”. During this process, an injection molding compound, in particular a plastic, in particular a thermoplastic, is molded onto a semifinished product, in particular onto a composite sheet, in an injection molding tool 4.

The composite sheet is a fiber composite component, wherein the as yet unshaped composite sheet is, in particular, a semifinished fiber matrix product consisting of a woven or non-crimped fabric embedded in a thermoplastic. The composite sheet can be hot formed, e.g. by being heated by infrared light irradiation and then formed, e.g. by insertion into a corresponding mold, e.g. by insertion into the injection molding tool 4. The seat shell 2 as a composite component consisting of the composite sheet and the molded-on injection molding compound has, in particular, a low weight and a high stability.

In the combination consisting of a seat shell 2 as a composite component and metal components, in particular in the form of the tubular frame, for the seat substructure, these two construction elements are load bearing and designed in such a way that they accommodate the body of a vehicle occupant and represent as far as possible a minimum block dimension. By virtue of the high stiffness and strength of the metal components, the composite component, i.e. the seat shell 2, is relieved of load in dynamic load cases. In this case, the combination of the composite component, i.e. seat shell 2, and the tubular frame is formed in such a way, for example, that the forces in the composite component, i.e. in the seat shell 2, and the tubular frame are dissipated in a preferential direction. By virtue of the free configurability of the seat shell 2 as a composite component, the shape of the posterior of the occupant or a dummy can be accommodated with uniform spacing.

As shown in FIGS. 2 and 3, the seat shell 2 is configured in such a way that a height of lateral cheeks 6 of the seat shell 2 can be varied by modifying a cavity K in the injection molding tool, in particular by means of interchangeable inserts 5 in the injection molding tool 4. It is thereby possible, e.g. by means of the same injection molding tool 4, to produce at least two different versions, i.e. embodiments, of the seat shell 2.

One of these embodiments of the seat shell 2, illustrated in FIG. 2, is a sporty version, for example, in which the lateral cheeks 6 are of higher design for better lateral retention. The other embodiment of the seat shell 2, illustrated in FIG. 3, is a basic version, for example, in which the lateral cheeks 6 are of lower design for easier entry and exit.

A device 7 for producing such seat shells 2 for vehicle seats 1 is shown schematically in highly simplified form in a section in FIG. 4. It comprises the injection molding tool 4, in which the injection molding compound, in particular composed of plastic, in particular of thermoplastic, can be molded onto the semifinished product, in particular onto the composite sheet, in order to form at least the lateral cheeks 6 of the respective seat shell 2. To produce the different embodiments of the seat shell 2, which differ in the lateral cheek height, the cavity K in the injection molding tool 4 can be modified in a forming region for the lateral cheeks 6.

In the example illustrated here, the interchangeable inserts 5 are provided for this purpose, which can be inserted into the injection molding tool 4 in order to modify the cavity K in the injection molding tool 4 in the forming region for the lateral cheeks 6. In this case, a respective interchangeable insert 5 is advantageously provided for the forming region for the respective lateral cheek 6, and therefore, when using the interchangeable inserts 5, two interchangeable inserts 5 are arranged in the injection molding tool 4. These two interchangeable inserts 5 can be connected to one another, thus enabling them to be jointly inserted into and removed from the injection molding tool 4, for example, or they can be individual elements and thus be capable of being separately inserted into and removed from the injection molding tool 4.

It is possible, for example, for at least two interchangeable insert types to be provided, which differ in particular in the height H thereof. The interchangeable inserts 5 of the respective interchangeable insert type can be selected and are to be arranged in the injection molding tool 4 in accordance with the envisaged lateral cheek height to be formed, wherein the interchangeable inserts 5 of the interchangeable insert type of great height H are used to reduce the cavity K in the forming region for the lateral cheeks 6 to a greater extent, thus enabling the embodiment of the seat shell 2 with the low lateral cheeks 6 to be produced, and the interchangeable inserts 5 of the interchangeable insert type of low height H are used to reduce the cavity K to a lesser extent in the forming region for the lateral cheeks 6, thus enabling the embodiment of the seat shell 2 with the high lateral cheeks 6 to be produced.

As an alternative, provision can be made, for example, for interchangeable inserts 5 only of one interchangeable insert type to be present, these interchangeable inserts 5 being inserted into the injection molding tool 4, when the intention is to form seat shells 2 with low lateral cheeks 6, in order to reduce the cavity K in the injection molding tool 4 appropriately in the forming region for the lateral cheeks 6, and being removed from the injection molding tool 4 when the intention is to produce seat shells 2 with high lateral cheeks 6, with the result that the complete cavity K, in particular a complete cavity height KH, of the injection molding tool 4 is then available in the injection molding tool 4, in the forming region for the lateral cheeks 6, for the formation of the high lateral cheeks 6.

In the example illustrated here, interchangeable inserts 5 are arranged in the injection molding tool 4 in order to produce one of the embodiments of the seat shell 2. To produce the other embodiment of the seat shell 2, provision can be made either to remove the interchangeable inserts 5 from the injection molding tool 4 and thus to produce this embodiment of the seat shell 2 with the injection molding tool 4 without interchangeable inserts 5, or to replace the interchangeable inserts 5 with interchangeable inserts 5 of a different interchangeable insert type, i.e. to remove the interchangeable inserts 5 from the injection molding tool 4 and insert interchangeable inserts 5 of the other interchangeable insert type into the injection molding tool 4.

In a method for producing seat shells 2 for vehicle seats 1, this device 7 is thus used to produce at least two different embodiments of seat shells 2, which differ in lateral cheek height, by adjusting the cavity K in the injection molding tool 4 in the forming region for the lateral cheeks 6 in accordance with the respective embodiment of the seat shell 2 to be produced.

In the example illustrated here, the embodiment of the seat shell 2 with low lateral cheeks 6 is produced by arranging interchangeable inserts 5 in the injection molding tool 4, and the embodiment of the seat shell 2 with high lateral cheeks 6 is produced by not arranging interchangeable inserts 5 in the injection molding tool 4 or by arranging in said tool interchangeable inserts 5 of a different interchangeable insert type which have a lower height H than the interchangeable inserts 5 used to produce the embodiment of the seat shell 2 with low lateral cheeks 6.

That is to say that, when a plurality of interchangeable insert types is used and interchangeable inserts 5 are used to produce both embodiments of the seat shell 2, the embodiment of the seat shell 2 with low lateral cheeks 6 is produced by arranging in the injection molding tool 4 interchangeable inserts 5 which have a great height H, in particular a greater height H than the interchangeable inserts 5 which are used to produce the embodiment of the seat shell 2 with high lateral cheeks 6, in order to greatly reduce the cavity K, in particular the cavity height KH thereof, in the injection molding tool 4 in the forming region for the lateral cheeks 6, and the embodiment of the seat shell 2 with high lateral cheeks 6 is produced by arranging in the injection molding tool 4 interchangeable inserts 5 of a different interchangeable insert type, which have a lower height H than the interchangeable inserts 5 which are used to produce the embodiment of the seat shell 2 with low lateral cheeks 6, in order to reduce the cavity K, in particular the cavity height KH thereof, in the injection molding tool 4 in the forming region for the lateral cheeks 6 to a lesser extent.

In particular, the respective seat shell 2 is produced by inserting the semifinished product, in particular the composite sheet, into the injection molding tool 4 and molding on the injection molding compound, in particular composed of plastic, in particular of thermoplastic, in order to form at least the lateral cheeks 6 of the seat shell 2.

For example, reinforcing structures, in particular rib structures and/or honeycomb structures, and/or at least one receptacle for an attachment to be secured on the vehicle seat 1 or a plurality of such receptacles for a plurality of attachments are furthermore formed by the molding on of the injection molding compound.

For example, the semifinished product, in particular the composite sheet, is heated before insertion into the injection molding tool 4, in particular by infrared light radiation, until it can be deformed, and is formed before insertion into the injection molding tool 4 or in the injection molding tool 4.

By means of the solution described, in particular through the modifiability of the cavity K in the injection molding tool 4 in a forming region for the lateral cheeks 6, which, in the example illustrated here, is implemented by means of the interchangeable inserts 5 for the injection molding tool 4, low-cost formation of different versions of the seat shell 2 is made possible since a plurality of embodiments of the seat shell 2, which differ, in particular, in lateral cheek height, can be produced with the same injection molding tool 4.

In other illustrative embodiments, the modifiability of the cavity K in the injection molding tool 4 in the forming region for the lateral cheeks 6 can also be implemented in a different way, e.g. by means of an adjustable wall of an injection mold of the injection molding tool 4 or in some other way.

### LIST OF REFERENCE SIGNS

1 vehicle seat

2 seat shell

3 seat back

4 injection molding tool

5 interchangeable insert

6 lateral cheek

7 device

H height

K cavity

KH cavity height

1-9. (canceled)

10. A device for producing seat shells for vehicle seats, comprising an injection molding tool in which an injection molding compound comprised a plastic, including a thermoplastic, can be molded onto a semifinished product, including onto a composite sheet, in order to form at least lateral cheeks of the respective seat shell, wherein a cavity in the injection molding tool can be modified in a forming region for the lateral cheeks.

11. The device as claimed in claim 10, wherein interchangeable inserts are provided that can be inserted into the injection molding tool in order to modify the cavity in the injection molding tool in the forming region for the lateral cheeks.

12. The device as claimed in claim 11, wherein the interchangeable inserts can each be secured positively and/or nonpositively in the injection molding tool.

13. The device as claimed in claim 11, wherein at least two interchangeable insert types are provided, which differ in particular in the height thereof.

14. A method for producing seat shells for vehicle seats, wherein at least two different embodiments of seat shells, which differ in a lateral cheek height, are produced by an injection molding tool in which an injection molding compound comprised a plastic, including a thermoplastic, can be molded onto a semifinished product, including onto a composite sheet, in order to form at least lateral cheeks of the respective seat shell, wherein a cavity in the injection molding tool can be modified in a forming region for the lateral cheeks by adjusting the cavity in the injection molding tool in the forming region for the lateral cheeks.

15. The method as claimed in claim 14, wherein the seat shell with low lateral cheeks is produced by arranging interchangeable inserts in the injection molding tool, and the embodiment of the seat shell with high lateral cheeks is produced by not arranging interchangeable inserts in the injection molding tool or by arranging in said tool interchangeable inserts of a different interchangeable insert type which have a lower height than the interchangeable inserts used to produce the embodiment of the seat shell with low lateral cheeks.

16. The method as claimed in claim 15, wherein the respective seat shell is produced by inserting a semifinished product, including a composite sheet, into the injection molding tool and molding on an injection molding compound, comprised a plastic, including a thermoplastic, in order to form at least the lateral cheeks of the seat shell.

17. The method as claimed in claim 14, wherein reinforcing structures, including rib structures and/or honeycomb structures, and/or at least one receptacle for an attachment to be secured on the vehicle seat are furthermore formed by the molding on of the injection molding compound.

18. The method as claimed in claim 14, wherein the semifinished product is heated before insertion into the injection molding tool until it can be deformed, and is formed before insertion into the injection molding tool or in the injection molding tool.
